(19) United States
(12) Patent Application Publication
(10) Pub. No.: US 2004/0076944 A1
(43) Pub. Date: Apr. 22, 2004

(54) Supervised learning in the presence of null data

(75) Inventors: Wai T. Chan, Newburyport, MA (US); Edward A. Reitman, Nashua, NH (US)

Correspondence Address: TESTA, HURWITZ & THIBEAULT, LLP, HIGH STREET TOWER, 125 HIGH STREET, BOSTON, MA, 02110, US

(73) Assignee: Ibex Process Technology, Inc., Lowell, MA

(21) Appl. No.: 10/645,120

(22) Filed: Aug. 21, 2003

Related U.S. Application Data
(60) Provisional application No. 60/405,172, filed on Aug. 22, 2002.

(51) Int. Cl. G09B 1/00

(52) U.S. Cl. 434/433

(57) ABSTRACT

Non-linear regression models are configured and trained to operate in connection with data sets having null (unknown) values.

### FIELD OF THE INVENTION

The invention relates generally to the field of data processing and process control and, in particular, to training non-linear regression models of complex multi-step processes.

### BACKGROUND

Process prediction and control is crucial to optimizing the outcome of complex multi-step production processes. The production process for integrated circuits, for example, comprises hundreds of process steps. Each process step, in turn, may have several operational variables, or inputs, that affect the outcome of the process step, subsequent process steps, and/or the process as a whole. In addition, the impact of the operational variables on outcome may vary from process-run to process-run, day-to-day, or hour-to-hour. Thus, the typical integrated circuit fabrication process has a thousand or more controllable inputs, any number of which may be cross-correlated and have a time-varying, nonlinear relationship with the process outcome. As a result, process prediction and control is crucial to optimizing process parameters and to obtaining, or maintaining, acceptable outcomes.

One approach to complex process prediction and control is to use a non-linear regression model of the process. Typically, however, non-linear regression models must first be trained in the relationship between measured operational variables of a process, which serve as model input variables, and the associated process outcomes, which serve as model output variables. Training is typically conducted with data sets from actual process runs that contain measured values of process input variables and output variables. Generally, the accuracy of a non-linear regression model increases with the number and completeness of the training data sets used to train the model.

Unfortunately, training data sets are often incomplete. In many cases, values for the model input variables and/or the model output variables are missing. Typical training approaches either ignore missing values or assign them a zero value. These approaches, however, can introduce error into the process model because the variables with missing values may contribute to process outcome. Further, any such contribution is likely to arise from a non-zero value. Accordingly, ignoring missing values or assigning them a zero value introduces errors that reduce the accuracy of a non-linear regression model and/or increases the time and cost associated with training the non-linear regression model. Therefore, what is needed is an approach to training non-linear regression models of complex processes that reduces the error associated with training data sets that are missing values for the model input variables and/or the model output variables.

### SUMMARY OF THE INVENTION

The present invention provides methods for training a non-linear regression model of a complex process using data sets that are missing values for the model input variables and/or the model output variables. Methods in accordance with the present invention do not ignore variables with missing values or assume that they have a zero value. The present invention can reduce the error in a non-linear regression model and the training time associated with using training data sets that are missing values.

A method in accordance with the invention uses a training data set. A training data set comprises one or more training vectors. A training vector is a combination of a target output vector and the corresponding input vector. An input vector, for example, is a set of values for the nodes of an input layer in the non-linear regression model that may include null data. As used herein, the term “null data” refers to a missing variable value. A target output vector, for example, is a set of values for the nodes of the output layer in the non-linear regression model that may include null data. Each target output vector corresponds to one specific input vector. In embodiments in which a complex manufacturing process is modeled, the input vector and the target output vector may correspond to process parameters measured during process operation.

Embodiments of the present invention use operational variables and metrics in the process of training the non-linear regression model of a complex process. As used herein, the term “operational variables” includes manipulated variables, replacement variables, and calibration variables. As used herein, the term “manipulated variables” refers to process controls that can be manipulated to vary the process procedure. One example of a manipulated variable is a set point adjustment. As used herein, the term “replacement variables” refers to variables that indicate the wear, repair, or replacement status of a sub-process component(s). As used herein, the term “calibration variables” refers to variables that indicate the calibration status of the process controls. Acceptable values of operational variables include, but are not limited to, continuous values, discrete values, and binary values. As used herein, the term “metric” refers to any parameter used to measure the outcome or quality of a process or process step (e.g., the yield, a quantitative indication of output quality, etc.). Metrics include parameters determined both in situ, i.e., during the running of a process or process step, and ex situ, at the end of a process or process step.

In an embodiment in which the modeled process involves plasma etching of silicon wafers, for example, the input variables may include operational variables, such as RF power and gas flow, time since the last RF electrode replacement, and time since the last mass flow controller (MFC) calibration. Similarly, in such embodiments, the output variables may include metrics of the process, such as etch rate and uniformity.

In one aspect, the invention comprises a method of training a non-linear regression model of a complex process having operational variables and associated process outcomes. In accordance with the method, a connection weight between each of a plurality of output variables and each of a plurality of input variables in the non-linear regression model is determined using a first weight relationship if at least the input variable and/or the output variable is a null data value and using a second weight relationship if neither the input variable or the output variable is a null data value.

In embodiments of the foregoing aspect, the method features two steps in which a connection weight between each of a plurality of output variables and each of a plurality of input variables in the non-linear regression model is determined. In the first step, the connection weights are determined using a first data set that does not include any null data values. In another step, the connection weights are determined using a second data set that does include at least one null data values and the previously determined connection weights. In some such embodiments, the first step is repeated before the other step is performed.

In some embodiments of the invention, the non-linear regression model comprises a neural network. A neural network can be organized as a series of nodes (which may themselves be organized into layers) and connections among the nodes, which connections are each given a weight corresponding to the strength of the connection. For example, in one embodiment, the non-linear regression model comprises at least a first hidden layer that is connected to the input variables (organized as nodes of an input layer with each node corresponding to a separate input variable) and an output layer that is connected to one or more of the hidden layers (where each node of the output layer corresponds to a separate output variable).

In such embodiments of the foregoing aspect, the method involves training a non-linear regression model of a complex process having at least three layers, each layer having a plurality of nodes. The method features two steps in which a connection weight is determined. First, a first connection weight between a node of an output layer and a node of a last hidden layer of the non-linear regression model is determined. Then, a second connection weight between a node of an input layer and a node of a first hidden layer is determined by back-propagating the first connection weight. The two steps are repeated using a data set comprising at least one variable with a null data value until a weight change between repetitions satisfies a convergence criterion.

In various embodiments in which the non-linear regression model comprises a neural network having one or more gate layers, there may be a gate layer is associated with the input layer, the output layer, and/or one or more hidden layers. As used herein, the term “gate layer” refers to a layer that can be used to modify the determination of a connection weight based on whether the input into the gate layer is null data. In such embodiments, the invention may include choosing one of two values for each of the plurality of nodes comprising the gate layer: a first value if the corresponding node in the associated layer represents null data and a second value if the corresponding node in the associated layer does not represent null data. In these embodiments, the values of nodes in a gate layer may be used to determine which weight relationship to use.

In embodiments, the one or more steps of determining a connection weight are repeated until a weight change between repetitions satisfies a convergence criterion.

In another aspect, the invention comprises an article of manufacture for training a non-linear regression model of a complex process. The article of manufacture includes a process monitor and a data processing device in signal communication with the process monitor. The process monitor provides information representing values of a plurality of operational variables and corresponding values of a plurality of process metrics. The data processing device receives the information and determines a plurality of connection weights to be used in the non-linear regression model from the information. Each of the plurality of connection weights is determined using a first weight relationship if the operational variable and/or the corresponding process metric has a null data value and using a second weight relationship if neither the operational variable or the corresponding process metric has a null data value.

In embodiments of the foregoing aspect, the non-linear regression model of a complex process comprises at least three layers, each layer having a plurality of nodes. In such embodiments, the process monitor provides information representing values for a plurality of nodes of an output layer and corresponding values of a plurality of nodes of an input layer. The data processing device, in these embodiments, determines a first connection weight between a node of an output layer and a node of a last hidden layer of the non-linear regression model from the information and a second connection weight between a node of an input layer and a node of a first hidden layer of the non-linear regression model by back-propagating the first connection weight. The data processing device determines the connection weights using a first weight relationship if a node contains a null data value and a second weight relationship if a node does not contain a null data value.

In embodiments of the foregoing aspect, the data processing device also determines if a convergence criterion is satisfied. In some such embodiments, each of the plurality of connection weights corresponds to one of the plurality of process metrics and one of the plurality of operational variables.

In embodiments of the foregoing aspects, the weight relationship used to determine connection weights when at least one of the two nodes has a null data value is of the form:

wᵢⱼ(t+1)=wᵢⱼ(t)+α(wᵢⱼ(t)−wᵢⱼ(t−1))

where wᵢⱼ(t+1) represents a connection weight between a node i and a node j for a repetition t+1 of steps (a) and (b), wᵢⱼ(t) represents a connection weight between the node i and the node j for a repetition t of steps (a) and (b) prior to the repetition t+1, α is a momentum coefficient, and wᵢⱼ(t−1) represents a connection weight between the node i and the node j for a repetition t−1 of steps (a) and (b) prior to the repetition t.

In embodiments of the foregoing aspects, the weight relationship used to determine connection weights when neither node has a null data value is of the form:

$${w}_{ij} ( t + 1 ) = η \frac{\partial E}{\partial {w}_{ij} ( t )} + {w}_{ij} ( t ) + α ( {w}_{ij} ( t ) - {w}_{ij} ( t - 1 ) )$$

where wᵢⱼ(t+1) represents a connection weight between a node i and a node j for a repetition t+1 of steps (a) and (b), η is a learning rate parameter, E represents an error associated with output of a plurality of nodes j, wᵢⱼ(t) represents a connection weight between the node i and the node j for a repetition t of steps (a) and (b) prior to the repetition t+1, α is a momentum coefficient, and wᵢⱼ(t−1) represents a connection weight between the node i and the node j for a repetition t−1 of steps (a) and (b) prior to the repetition t.

In some of the foregoing embodiments, the momentum coefficient α and/or the learning rate parameter η is greater than zero and less than or equal to one. In some such embodiments, the input values are normalized to have a mean of zero and the learning rate parameter η is greater than zero but less than about 0.5. In some of the foregoing embodiments, the momentum coefficient α and/or the learning rate parameter η may vary, for example, as a function of the number of times connection weight has been calculated.

In embodiments of the foregoing aspects, the process monitor comprises a database or a memory element including a plurality of data files. In some embodiments the training sets include binary values and scalar numbers representing operational variables or associated process metrics. In some such embodiments, one or more of scalar numbers is normalized with a zero mean.

In embodiments of the foregoing aspects, the data processing device comprises a module embedded on a computer-readable medium, such as, but not limited to, a floppy disk, a hard disk, an optical disk, a magnetic tape, a PROM, an EPROM, CD-ROM, or DVD-ROM.

### BRIEF DESCRIPTION OF THE DRAWINGS

A fuller understanding of the advantages, nature and objects of the invention may be gained by reference to the following illustrative description, when taken in conjunction with the accompanying drawings. The drawings are not necessarily drawn to scale, and like reference numerals refer to the same parts throughout the different views.

FIG. 1A is a schematic representation of one embodiment of a non-linear regression model for a complex process trained according to approaches of the present invention.

FIG. 1B is a schematic representation of another embodiment of a non-linear regression model for a complex process trained according to approaches of the present invention.

FIG. 2 is a flow diagram illustrating a method of training a non-linear regression model for a complex process in accordance with embodiments of the present invention.

FIG. 3 is a flow diagram illustrating a method of determining a connection weight between measured operational variables and associated process outcomes used in embodiments of the present invention.

FIGS. 4A and 4B are a flow diagram illustrating one embodiment of training a non-linear regression model according to the present invention.

FIG. 5 is a system in accordance with embodiments of the present invention.

FIGS. 6-16 are learning curves for a non-linear regression model with various amounts of null data in the input vector of a training data set. FIG. 6 is a learning curve for an input vector of a training data set with no null data (i.e., 0% null data). FIG. 7 is a learning curve for an input vector with approximately 5% null data. FIG. 8 is a learning curve for an input vector with approximately 10% null data. FIG. 9 is a learning curve for an input vector with approximately 20% null data. FIG. 10 is a learning curve for an input vector with approximately 30% null data. FIG. 11 is a learning curve for an input vector with approximately 40% null data. FIG. 12 is a learning curve for an input vector with approximately 50% null data. FIG. 13 is a learning curve for an input vector with approximately 60% null data. FIG. 14 is a learning curve for an input vector with approximately 70% null data. FIG. 15 is a learning curve for an input vector with approximately 80% null data and FIG. 16 is a learning curve for an input vector with approximately 90% null data.

FIG. 17 is a graph comparing the training of the non-linear regression model of FIGS. 5-15, as measured by the average root mean square error, as a function of the amount of null data in the input vector of a training data set. The error bars represent ±5%.

FIG. 18 is a graph comparing the performance of non-linear regression models trained with training data sets comprising 0%, 10% and 90% null data, in reproducing a known set of target outputs of a training data set having no null data.

### DETAILED DESCRIPTION

A non-linear regression model useful in accordance with the present invention is preferably trained by comparing calculated output variable values, based on the input vector of a target vector, with the values of the variables in the target output vector (i.e., target values) for a plurality of target vectors. For example, a first target vector may be selected and the difference between calculated and target values used to determine the output layer error. The output layer error is in turn used to calculate values for the adjustable parameters of the regression model. The approach of determining the error and adjustable parameters is iterated until the change in the adjustable parameters between iterations satisfies one or more convergence criteria, with target vectors selected between iterations. If the regression model is a neural network, these adjustable parameters are the connection weights between the layers of nodes in the network.

It is to be understood that in training a non-linear regression model, any training vector in the training data set may be selected multiple times for use in determining the error and adjustable parameters. The number of target vectors in the training data set may, for example, be two or more orders of magnitude less than the number of iterations performed in training a non-linear regression model of a complex process. As a result, a single training vector can be used hundreds of times in the iterative process of determining adjustable parameter values until the changes in these values between iterations satisfies the convergence criterion or criteria.

In one aspect, the present invention is a training method that determines for an iteration t the connection weights wᵢⱼ(t) between a layer node i in a layer I having i nodes and a node j in a layer J having j nodes, using various modifications (described more fully below) of a weight relationship of the form:

$${w}_{ij} ( t + 1 ) = η \frac{\partial E}{\partial {w}_{ij} ( t )} + {w}_{ij} ( t ) + α ( {w}_{ij} ( t ) - {w}_{ij} ( t - 1 ) ) \qquad Eq . ( 1 ) ,$$

where wᵢⱼ(t+1) is the connection weight for the next iteration t+1, E represents the error of the network at iteration t, η denotes a proportionality factor referred to as the learning rate, and α denotes a factor that is referred to herein as the “momentum coefficient.” In one embodiment, the network error E is equal to one-half of the sum of the squared error of all the output nodes in the output layer. As written, the first term η adjusts the step size while “stepping down” the gradient

$$\frac{\partial E}{\partial {w}_{ij} ( t )} .$$

For example, the distance between iterations on a plot of the error E as a function of the connection weights is based on the value of the learning rate. The second term wᵢⱼ(t) is the connection weight value determined for the current iteration t and the third term contains the connection weight from the prior iteration wᵢⱼ(t−1). The third term α(wᵢⱼ(t)−wᵢⱼ(t−1)) is referred to herein as the momentum term because it can be used to adjust the speed of descent down the gradient. For example, the third term can act to reduce abrupt adjustments created when there is a dramatic change in the connection weights between the weights of iterations t and (t−1). As illustrated by Equation 1, this can be accomplished by selecting a value for the momentum coefficient α that is less than one.

According to the present invention, there is a wide range of suitable values for both the learning rate η and the momentum coefficient α. Generally, for example, for variables normalized to a range between −1 and 1, where zero represents the mean value of the variable, η has a value in the range from about 0 to about 0.5. Preferably, for variable values normalized with a mean of zero, 77 is on the order of 0.0001. Preferably, the momentum coefficient, α, is a value that is greater than zero and less than or equal to one. For example, in one embodiment, the value of α is approximately 0.5. In another embodiment, the momentum coefficient α is slightly less than the value of the learning rate η.

Further, the values of the learning rate η and/or the momentum coefficient α need not remain constant from iteration to iteration. In various embodiments of the invention, the values of η and/or α vary based on the number of iterations performed, the change in the values of the adjustable parameters between iterations, the rate of change in the values of the adjustable parameters between iterations (e.g., how fast the differences (wᵢⱼ(t)−wᵢⱼ(t−1)), (wᵢⱼ(t+1)−wᵢⱼ(t)), etc., are changing), or combinations of the above.

It can be shown from Equation 1 that the determination of a connection weight for an iteration t becomes problematic when a target vector contains null data in the input vector or the target output vector because the gradient

$$\frac{\partial E}{\partial {w}_{ij} ( t )}$$

a may be undefined under those circumstances. For example, if layer J is the output layer, the gradient can be determined from,

$$\begin{matrix}\frac{\partial E}{\partial {w}_{i j} ( t )} = \frac{\partial E}{\partial {z}_{j}} \frac{\partial {z}_{j}}{\partial {w}_{i j} ( t )} , & Eq . ( 2 ) \\ \frac{\partial E}{\partial {z}_{j}} = - ( {d}_{j} - {z}_{j} ) = {z}_{j} - {d}_{j} , & Eq . ( 3 ) \\ \frac{\partial {z}_{j}}{\partial {w}_{i j} ( t )} = \frac{\partial }{\partial {w}_{i j} ( t )} ( {\sum }_{i} {w}_{i j} {y}_{i} ) = {y}_{i} , & Eq . ( 4 )\end{matrix}$$

hence the gradient can be expressed as,

$$\frac{\partial E}{\partial {w}_{i j} ( t )} = ( {z}_{j} - {d}_{j} ) {y}_{i} , \qquad Eq . ( 5 )$$

where yᵢ is the input from node i, dⱼ is the target value for the output of node j, and zⱼ is the output of node j. As a result, Equation 5 is undefined when yᵢ, zⱼ and/or dⱼ are null data. Equation 5 also demonstrates that an inaccuracy is introduced by assigning an arbitrary value to yᵢ, zⱼ and/or dⱼ when a training vector includes null data. The approaches of the present invention facilitate resolving these problems by using modified versions of Equation 1 in the presence of null data so that the present training approach neither ignores nor assigns arbitrary values (such as zero) to null data variable values.

Specifically, in one embodiment of the present invention, when either yᵢ, zⱼ and/or dⱼ of iteration t represent null data, the connection weight wᵢⱼ(t+1) connecting the inputs yᵢ to the outputs zⱼ is determined from the weight relationship,

wᵢⱼ(t+1)=wᵢⱼ(t)+α(wᵢⱼ(t)−wᵢⱼ(t−1)) Eq. (6).

As illustrated by Equation 6, the approach of the present invention uses the momentum term to include information from the previous weight wᵢⱼ(t−1) in determining the next iteration weight wᵢⱼ(t+1) (i.e., the update to the current weight wᵢⱼ(t) ). For example, if the variable with a null data value in current iteration t did not have a null data value in the previous iteration (t−1), the update to the current weight is in the same direction as the previous update even though there is no real information describing how to adjust the weight for the current iteration.

In another embodiment, the approach of the present invention uses an exponentially decreasing momentum coefficient to facilitate continuous non-linear regression model training even where there is consecutive missing data for a particular input variable (e.g., a variable has a null data value in two or more consecutive iteration training vectors).

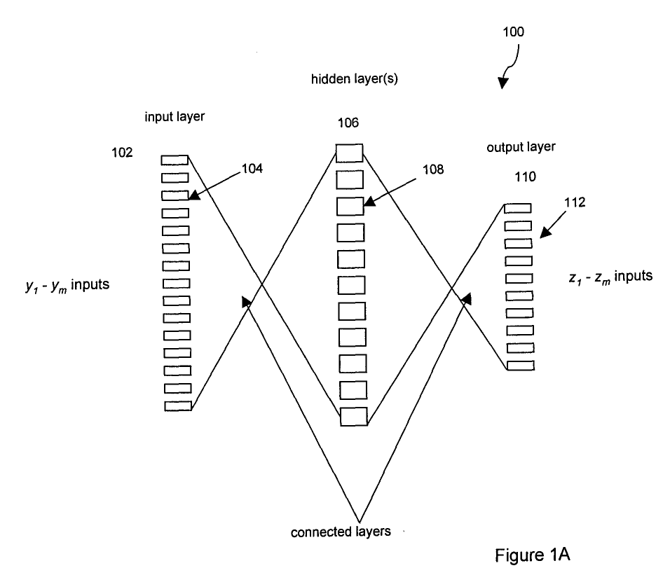

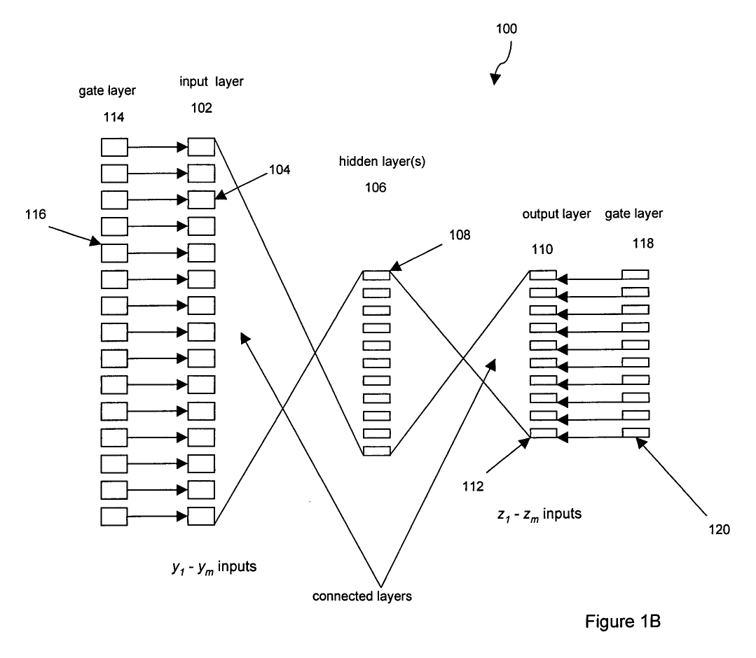

FIG. 1A is a schematic representation of one embodiment of a non-linear regression model for a complex process trained according to approaches of the present invention. Specifically, FIG. 1A illustrates a neural network model 100 using m input variables y for an input layer 102 comprising m nodes 104, a first hidden layer 106 of n nodes 108, and q output variables z for an output layer 110 comprising q nodes 112 is illustrated. As shown, the network of FIG. 1A comprises a 15-11-10 architecture, i.e., the dimension of the input layer is 15 (m=15), that of the first hidden node is 11 (n=11), and that of the output layer is 10 (q=10).

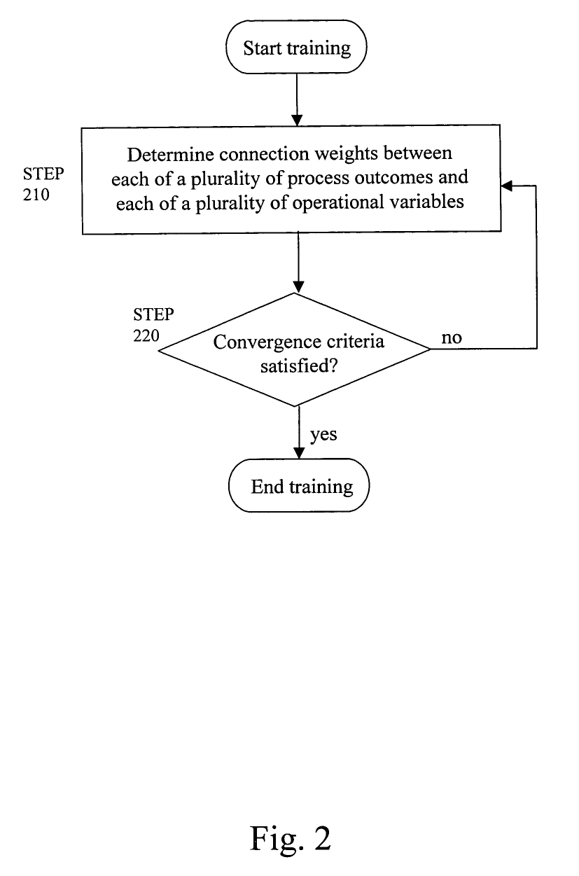

FIG. 2 is a flowchart illustrating a method of training a non-linear regression model for a complex process according to embodiments of the present invention. In step 210 of FIG. 2, connection weights between each of a plurality of output variables and each of a plurality of input variables are determined. In step 220 of FIG. 2, one or more convergence criteria is evaluated. If the convergence criteria is satisfied, the training is ended. If the convergence criteria is not satisfied, step 210 is repeated. The process repeats until the convergence criteria is satisfied.

In embodiments in which the non-linear regression model is a neural network similar to the neural network illustrated in FIG. 1A, each of the plurality of operational variables is represented by a node in input layer 102 and each of the plurality of process outcomes is represented by a node in output layer 110. In such embodiments, operational variables are also described as input variables and process outcomes are also described as output variables. In such embodiments, there is at least one hidden layer 106 between input layer 102 and output layer 110. Accordingly, in such embodiments, step 210 comprises determining a connection weight between a node in the output layer 110 and a node in the last hidden layer of the model, and back-propagating the first connection weight to determine a connection weight between a node of the input layer and a node in the first hidden layer of the model. In embodiments that include only one hidden layer, such as illustrated in FIG. 1A, the last hidden layer in the model is the first hidden layer and connection weights are calculated in two steps.

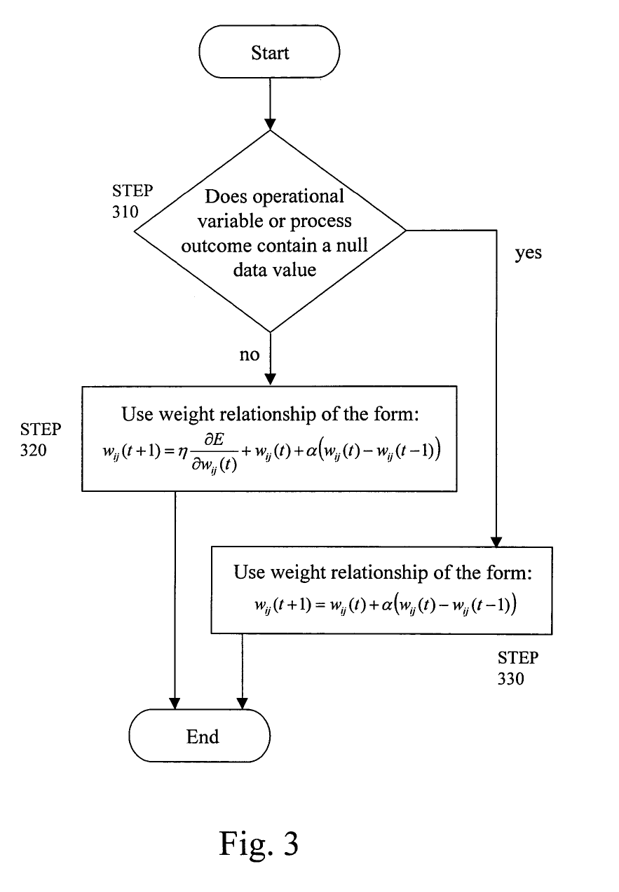

FIG. 3 is a flowchart illustrating a method of determining a connection weight between an operational variable and an associated process metric in a training vector for a non-linear regression model that is used in embodiments of FIG. 2. In step 310 of FIG. 3, it is determined whether the operational variable or the process metric contains a null data value. If there is no null data value, step 320 is performed. Otherwise, step 330 is performed. In step 320 of FIG. 3, a connection weight is determined using a weight relationship in the form of Equation 1. In step 330 of FIG. 3, a connection weight is determined using a weight relationship in the form of Equation 6.

In embodiments in which the non-linear regression model is a neural network similar to the neural network illustrated in FIG. 1A, each of the plurality of operational variables is represented by a node in input layer 102 and each of the plurality of process metrics is represented by a node in output layer 110. If either a node in the input layer 102 or a node in the output layer 110 contains a null value, step 330 is performed. Otherwise, step 320 is performed.

FIG. 1B is a schematic representation of another embodiment of a non-linear regression model for a complex process trained according to approaches of the present invention. Specifically, FIG. 1B illustrates a neural network model that uses one or more gating layers in training a non-linear regression model with training data sets having null data. FIG. 1B illustrates a neural network model 100 using m input variables y for an input layer 102 comprising m nodes 104, a first hidden layer 106 of n nodes 108, and q output variables z for an output layer 110 comprising q nodes 112 is illustrated. As shown, the network of FIG. 1B, like the network of FIG. 1A, comprises a 15-11-10 architecture, i.e., the dimension of the input layer is 15 (m=15), that of the first hidden node is 11 (n=11), and that of the output layer is 10 (q=10). FIG. 1B also features a gate layer 114 associated with input layer 102 and similarly comprising m nodes 116 and a gate layer 118 associated with output layer 110 and similarly comprising q nodes 120. It is to be understood that further gate layers may also be utilized with respect to one or more hidden layers. It also to be understood that embodiments of the invention incorporate only one gate layer.

As illustrated in FIG. 1B, each node of a gate layer is connected to one node of the layer for which it serves as a gate. Preferably, the values of any gate layer node are one of two values of a binary set of code values (e.g., 0 or 1, −1 or 1, etc.) where one of the values of the binary set signifies the presence of null data in the node to which the node of the gate layer is connected, and the other indicates the absence of null data in the node to which the node of the gate layer is connected.

In embodiments in which the non-linear regression model is a neural network similar to the neural network illustrated in FIG. 1B, the value of the gate layer node is used in step 310 of FIG. 3. In particular, the value of the gate layer node is used in step 310 to determine which step, step 320 or step 330, to perform in determining the connection weights wᵢⱼ(t+1). For example, for the first gate layer 114 where a gate node 116 code value of 0 indicates the presence of null data and a code value of 1 the absence, input nodes 104 with null data are fed through the gate layer are associated with the code value 0 and the connection weights wᵢⱼ(t+1) connecting the input layer nodes 104 and the first hidden layer nodes 108 are determined in step 330. Input nodes without null data are fed through the gate layer are associated with the code value 1 and the connection weights wᵢⱼ(t+1) connecting the input layer nodes 104 and the first hidden layer nodes 108 are determined in step 320. Similarly, the output gate layer 118 can be used to associate code values with a given output node 112 that in turn are used to determine whether the weights connecting the output layer nodes 112 and the nodes of the last hidden layer (here layer 106 since there is only one hidden layer illustrated in FIG. 1B) are determined in accordance with step 330 (null data is present in node or associated target value) or step 320 (null data is absent from node or associated target value).

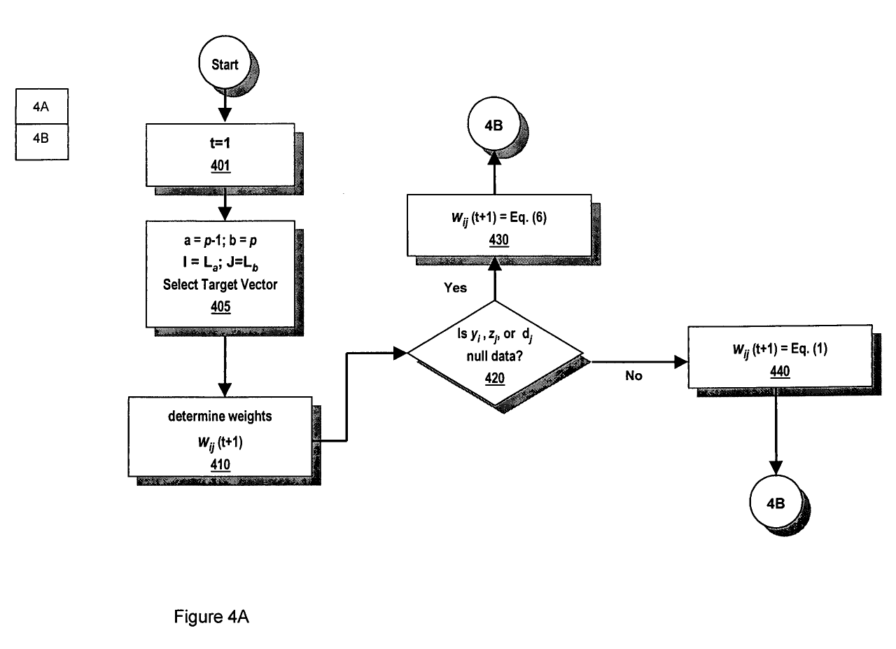

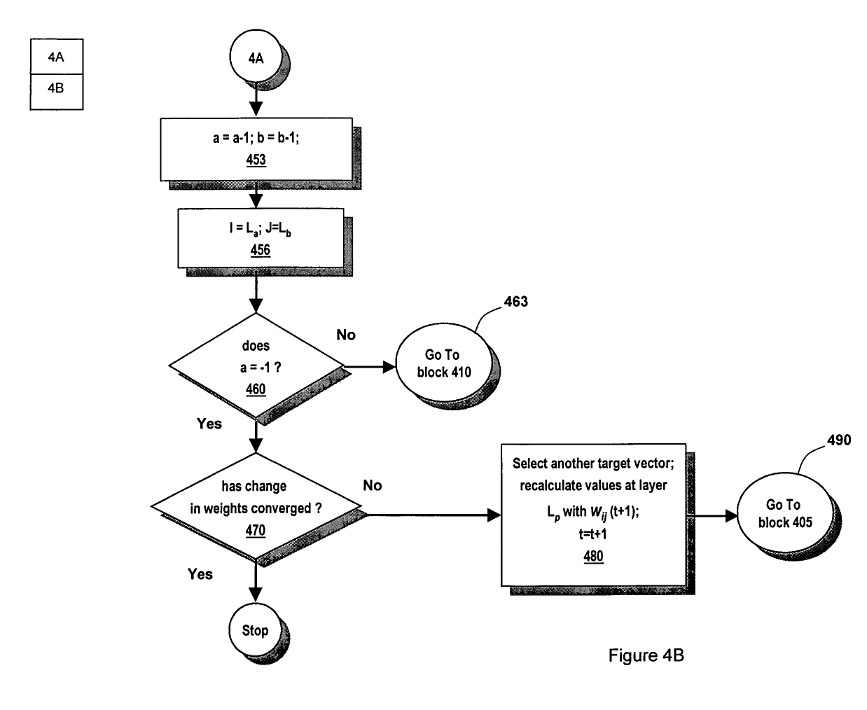

FIGS. 4A and 4B illustrate a flow diagram of one embodiment for the training of a non-linear regression model having p+1 layers Lᵥ (where v=0, 1, . . . , p−1, p), inclusive of an input layer Lᵥ₌₀ and an output layer Lᵥ₌ₚ. As used in FIGS. 4A and 4B, the indices i and j, and layer designations I and J, have the following meanings. The index i spans the nodes of a layer I and the index j spans the nodes of a layer J, where the output value zᵢ for node i of layer I serves as the input value yᵢ to layer J and that has an the output value zⱼ for node j. Further, as used in FIGS. 4A and 4B, t represents the current iteration of the training, (t−1) represents a prior iteration of the training, and (t+1) represents a subsequent iteration of the training.

Referring to FIGS. 4A-4B, a method of training a non-linear regression model is described in accordance with one embodiment of the invention in which the non-linear regression model is a neural network similar to the one illustrated in FIG 1A. Referring to FIGS. 1A and 4A, the training approach starts with selecting a target vector for the iteration t (blocks 401, 405). In the first iteration of the training (t=1), it is preferred that the target vector selected for the first iteration contain no null data or that an initial set of connection weights wᵢⱼ(t) be provided for those nodes associated with a null data input, null data output, and/or null data target value. Further, it is preferred that for the first iteration an initial set of connection weights wᵢⱼ(t−1) also be provided. In one embodiment, the values of the initial set of connection weights wᵢⱼ(t−1) for the first iteration (t=1) are zero or randomized.

The approach then proceeds to determine the connection weights wᵢⱼ (block 410) connecting the nodes 112 of the output layer J=Lₚ 110 to the nodes 108 of its predecessor layer I=Lₚ₋₁ 106. Where one or more of the values of yᵢ, zⱼ and dⱼ represent null data (“YES” to query 420), the connection weights wᵢⱼ can be determined from Equation 6 (block 430). Where the none of the values of yᵢ, zⱼ and dⱼ represent null data (“NO” to query 420), the connection weights wᵢⱼ can be determined from Equation 1 (block 440).

After the connection weights wᵢⱼ(t+1) are determined for initial layers I and J, the approach is continued back through the non-linear regression model. In accordance with FIGS. 4A and 4B, now layer I=Lₐ₌ₚ₋₂ and layer J=L_{b=p-1} (blocks 453 and 456). The approach continues to back propagate layer by layer through the non-linear regression model, determining connection weights wᵢⱼ (t+1) until the connection weights wᵢⱼ (t+1) of the nodes j of the first hidden layer J=L₁(layer 106 in FIG. 1A) and the nodes i 104 of the input layer 102 can be provided. For example, back propagation continues (answer to query 460 is “NO” and action 463) until the dummy index a=−1 (answer to query 460 is “YES”) indicating that the weights wᵢⱼ (t+1) connecting the input and first hidden layer have been determined. Where one or more of the values of yᵢ, zⱼ and dⱼ represent null data (“YES” to query 420), the connection weights wᵢⱼ can be determined from Equation 6 (block 430). Where the none of the values of yᵢ, zⱼ and dⱼ represent null data (“NO” to query 420), the connection weights wᵢⱼ can be determined from Equation 1 (block 440).

The training approach of FIGS. 4A and 4B is then iterated until the change in the value of the connection weights between iterations (e.g., {wᵢⱼ (t+1)−wᵢⱼ (t)}) satisfies a convergence criterion. If the convergence criterion is satisfied (“YES” to query 470) then the training is ended. If the convergence criterion is not satisfied (“NO” to query 470) then another target vector is selected, and the outputs of the model, i.e., the values of the nodes of the output layer Lₚ, are recalculated (block 480) using the connection weights wᵢⱼ(t+1). The approach of weight determination is then repeated (action 490, “Go To block 405”). The training rounds, or iterations, thus preferably continue until the convergence criterion is satisfied.

Again referring to FIGS. 4A-4B, a method of training a non-linear regression model is described in accordance with an alternative embodiment of the invention in which the non-linear regression model is a neural network similar to that illustrated in FIG. 1B. Referring to FIG. 1B, a first gate layer 114 having m nodes 116 is used to implement the functionality of one or more of blocks 420-440 with respect to null data values of yᵢ that may appear in the m nodes 104 of the input layer 102. A second gate layer 118 having q nodes 120 is used to implement the functionality one or more of blocks 420-440 with respect to null data values of zⱼ or dⱼ that may appear, respectively, in the nodes 112 of the output layer 110 or in the target output vector. It is to be understood that further gate layers may also be utilized with respect to one or more hidden layers.

In training the non-linear regression model, the value of the gate layer node is used to determine the weight relationship to use in determining the connection weights wᵢⱼ(t+1). For example, for the first gate layer 114 where a gate node 116 code value of 0 indicates the presence of null data and a code value of 1 the absence, input nodes 104 with null data are fed through the gate layer are associated with the code value 0 and the connection weights wᵢⱼ (t+1) connecting the input layer nodes 104 and the first hidden layer nodes 108 are determined in accordance with the weight relationship of Equation 6. Input nodes without null data are fed through the gate layer are associated with the code value 1 and the connection weights wᵢⱼ (t+1) connecting the input layer nodes 104 and the first hidden layer nodes 108 are determined in accordance with the weight relationship of Equations 1. Similarly, the output gate layer 118 can be used to associate code values with a given output node 112 that in turn are used to determine whether the weights connecting the output layer nodes 112 and the nodes of the last hidden layer (here layer 106 since there is only one hidden layer illustrated in FIG. 1B) are determined in accordance with Equation 6 (null data is present in node or associated target value) or Equations 1 (null data is absent from node or associated target value).

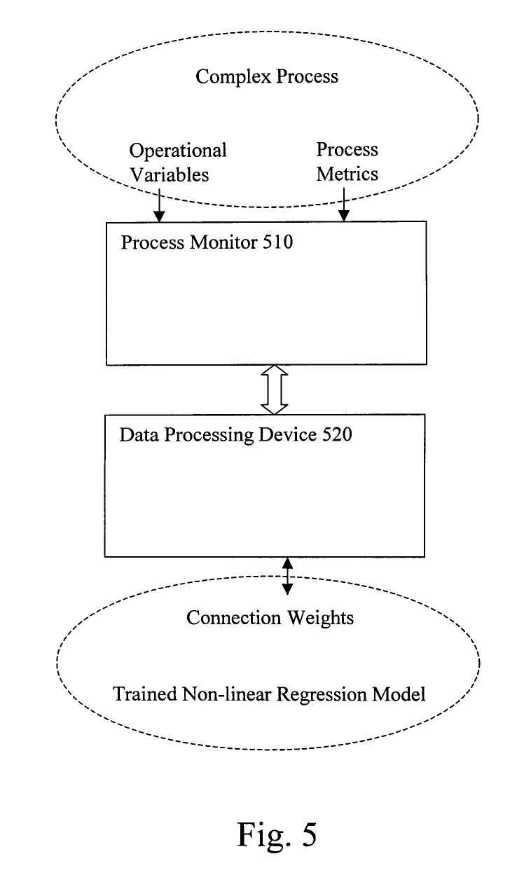

In other aspects, the present invention provides systems adapted to practice the methods of the invention set forth above. In embodiments illustrated by FIG. 5, the system comprises a process monitor 510 and a data processing device 520. The process monitor 510 may comprise any device that provides information on operational variables and/or process metrics. The process monitor 510 in some embodiments, for example, comprises a database that includes data from process sensor, yield analyzers, or the like. In related embodiments, the process monitor 510 is a set of files from a statistical process control database. Each file in the process monitor 510 may represent information relating to a specific process. The information may include binary values and scalar numbers. The binary values may indicate relevant technology and equipment used in the process. The scalar numbers may represent process metrics. The process metrics may be normalized. The normalization may have a zero mean and/or a unity standard deviation.

The data processing device 520 may comprise an analog and/or digital circuit adapted to implement the functionality of one or more of the methods of the present invention using at least in part information provided by the process monitor 510. The information provided by the process monitor 510 can be used directly to train a non-linear regression model of the process (e.g., by using operational variable information as values for variables in an input vector and process metrics as values for variables in a target output vector) or used to construct training data set for later use. In addition, in one embodiment, the systems of the present invention are adapted to conduct continual, on-the-fly training of the non-linear regression model.

In some embodiments, the data processing device 520 may implement the functionality of the methods of the present invention as software on a general purpose computer. In addition, such a program may set aside portions of a computer's random access memory to provide control logic that affects the non-linear regression model implementation, non-linear regression model training and/or the operations with and on the input variables. In such an embodiment, the program may be written in any one of a number of high-level languages, such as FORTRAN, PASCAL, C, C++, Tcl, or BASIC. Further, the program can be written in a script, macro, or functionality embedded in commercially available software, such as EXCEL or VISUAL BASIC. Additionally, the software could be implemented in an assembly language directed to a microprocessor resident on a computer. For example, the software can be implemented in Intel 80×86 assembly language if it is configured to run on an IBM PC or PC clone. The software may be embedded on an article of manufacture including, but not limited to, “computer-readable program means” such as a floppy disk, a hard disk, an optical disk, a magnetic tape, a PROM, an EPROM, or CD-ROM.

The invention has been implemented using empirical data from a plasma etch process. Specifically, the present invention was used to train a non-regression model comprising a neural with a 31-10-12 architecture; and a total of 480 connection weights. The training was accomplished using a training data set of 2084 target vectors with no null data. To demonstrate the effectiveness of the methods described herein, null data values were randomly added to the training data set at different percentage densities. In this example, the output variable is the plasma etch dc bias and the thirty-one input variables include parts age, pre-etch quality metrics (such as, the input line size and thickness measurement from the chemical mechanical polishing process), and monitor variables such as temperature, pressure and RF power.

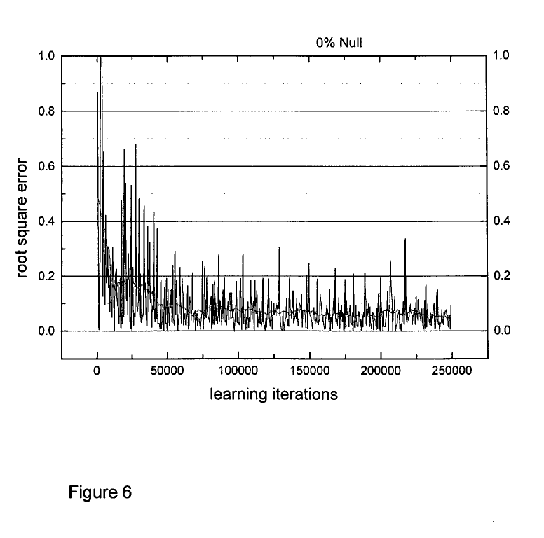

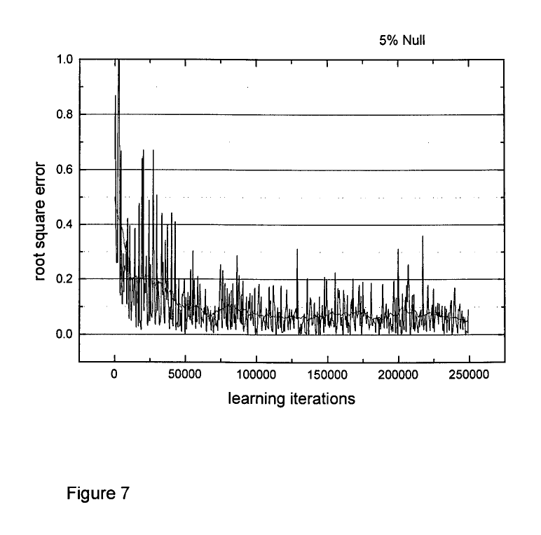

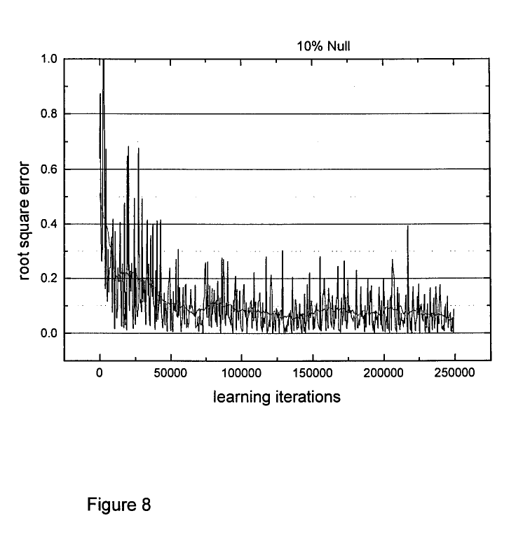

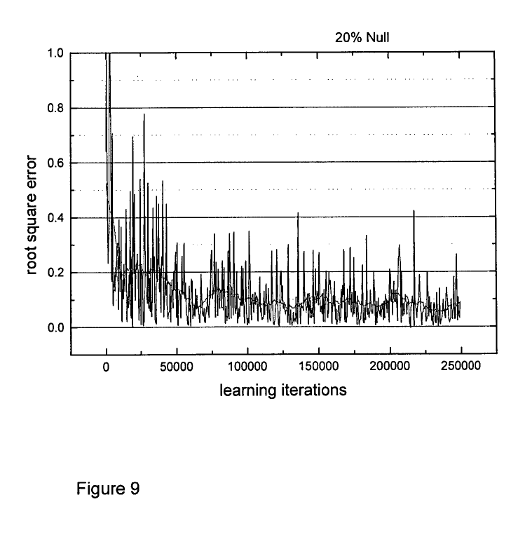

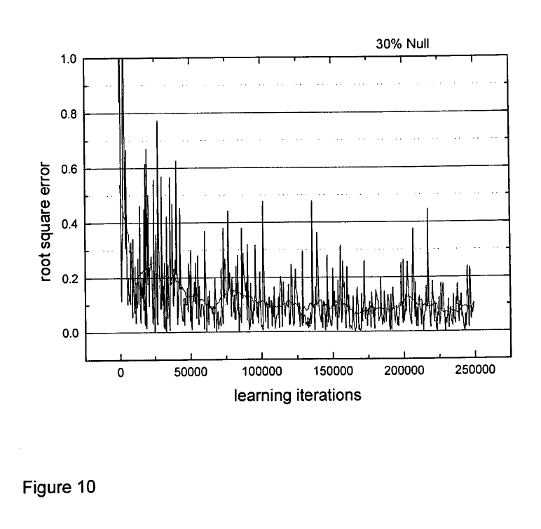

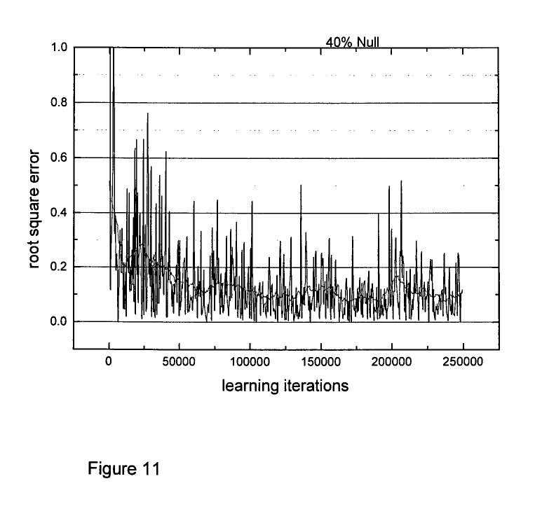

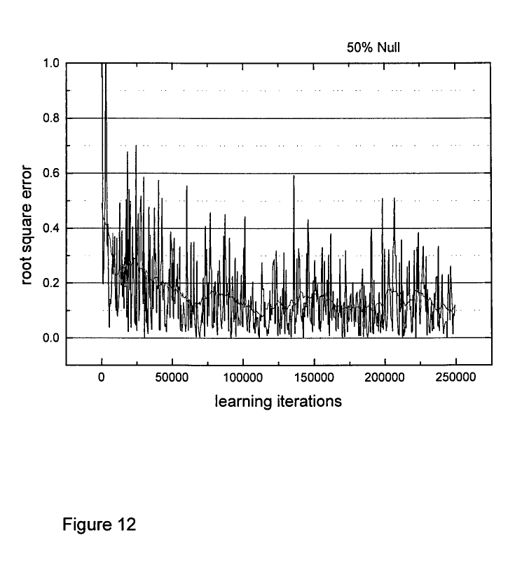

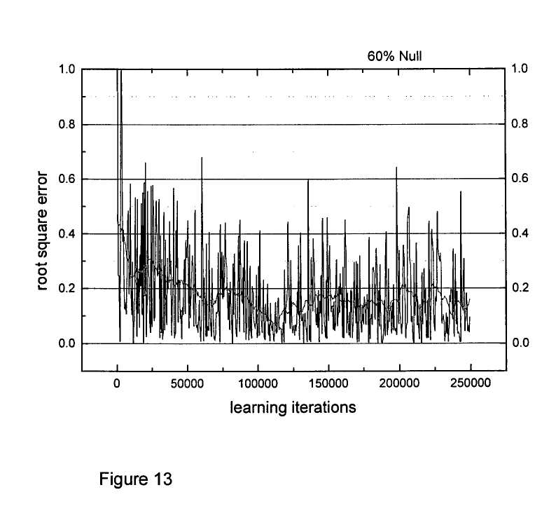

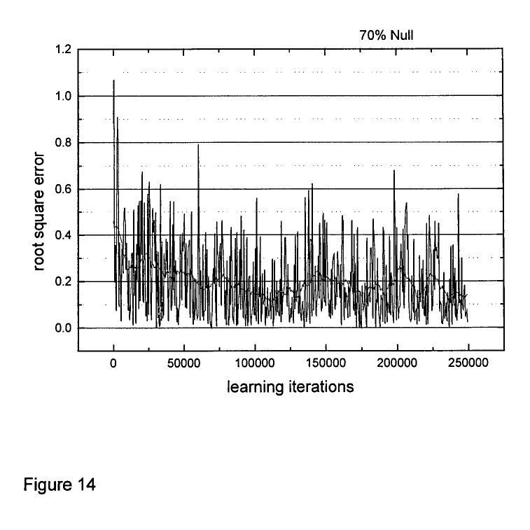

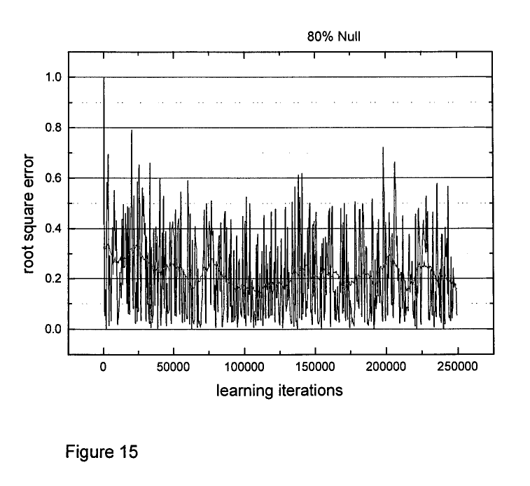

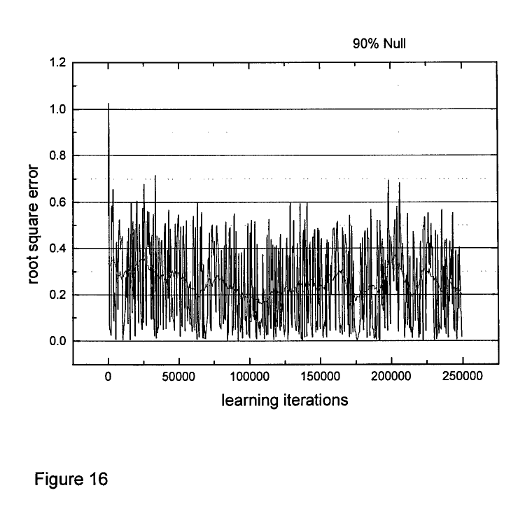

FIGS. 6-16 show learning curves for the dc bias variable value in the plasma etch process model. The y-axis for each plot is the root mean square error between the calculated output value and the target output value. The x-axis of each plot is the number of iterations which were used to train the model. The line running through the plotted data of FIGS. 6-16 is a moving average of the prior twenty-five iterations. The advantages that can be provided by the present invention are demonstrated in FIGS. 6-16, by the ability of the invention to train a non-linear regression model to predict the process output values to, in this example model, an acceptable margin of error even as the percentage of null data in the input vector increases to 90%.

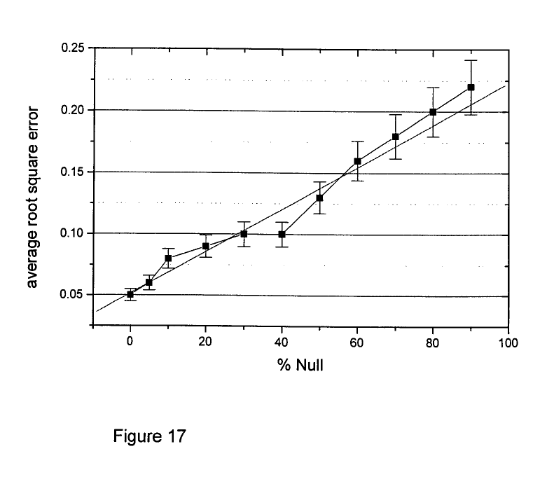

FIG. 17 is a graph of the average root square error versus the percentage of null data in the input vector. As described previously with respect to FIGS. 6-16, although the average root square error does increase along with an increase in null data, the ability of the invention to train a non-linear regression model to predict the process output values to, in this example model, an acceptable margin of error remains effective even with 90% null data.

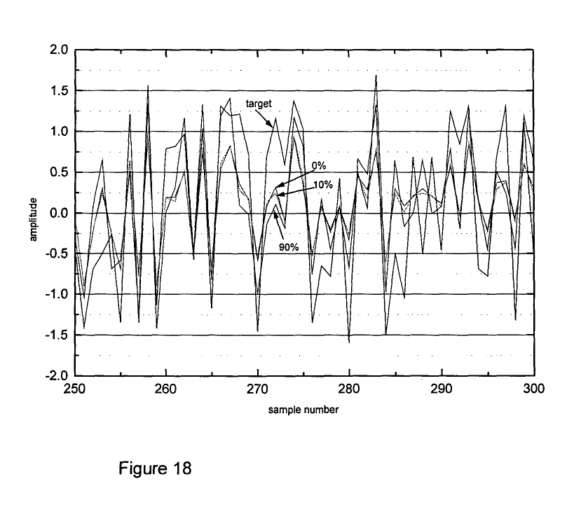

FIG. 18 further illustrates the method's functionality and benefits. FIG. 18 provides a comparison plot of the calculated output values at various percentages of null data (0%, 10%, and 90%) and target output values. The y-axis represents the value of an output variable and the x-axis the target output vector. Generally, the calculated output values closely tracks the target output values.

Illustrative descriptions of the invention in the context of a neural network models of a complex process are provided above. However, it is to be understood that the present invention may be applied to other non-linear regression models that use training data sets having null data. Additionally, although the examples described above relate to semi-conductor manufacturing, it will be recognized by those of ordinary skill in the art that approaches of the invention can be applied to a wide variety of non-linear regression models for industrial processes and dynamic systems such as telecommunication networks, biomedical health monitoring, data mining, and the like.

What is claimed is:

1. A method of training a non-linear regression model of a complex process having operational variables and associated process outcomes, the method comprising the step of:
determining a connection weight between each of a plurality of output variables and each of a plurality of input variables in the non-linear regression model using a first weight relationship if at least one of the input variable and the output variable comprises a null data value and using a second weight relationship if neither the input variable or the output variable comprise a null data value.

2. The method of claim 1 wherein the determining step comprises:
(a) determining a connection weight between each of a plurality of output variables and each of a plurality of input variables in the non-linear regression model using a first data set that does not comprise a null data value;
(b) determining the connection weight between each of the plurality of output variables and each of the plurality of input variables in the non-linear regression model using (i) a second data that does not comprise a null data value and (ii) the result of step (a); and
(c) determining the connection weight between each of the plurality of output variables and each of the plurality of input variables in the non-linear regression model using (i) a third data set comprising a null data value and (ii) the result of step (b).

3. The method of claim 1 wherein the non-linear regression model comprises at least three layers, each layer having a plurality of nodes, the determining step comprising:
(a) determining a first connection weight between a node of an output layer and a node of a last hidden layer of the non-linear regression model; and
(b) determining a second connection weight between a node of an input layer and a node of a first hidden layer of the non-linear regression model by back-propagating the first connection weight.

4. The method of claim 1, wherein the first weight relationship is of the form:
wᵢⱼ(t+1)=wᵢⱼ(t)+α(wᵢⱼ(t)−wᵢⱼ(t−1))
where wᵢⱼ(t+1) represents a connection weight between a node i and a node j for a repetition t+1 of steps (a) and (b), wᵢⱼ(t) represents a connection weight between the node i and the node j for a repetition t of steps (a) and (b) prior to the repetition t+1, α is a momentum coefficient, and wᵢⱼ(t−1) represents a connection weight between the node i and the node j for a repetition t −1 of steps (a) and (b) prior to the repetition t.

5. The method of claim 4, wherein the momentum coefficient a is greater than zero and less than or equal to one.

6. The method of claim 1, wherein the second weight relationship is of the form:
$${w}_{ij} ( t + 1 ) = η \frac{\partial E}{\partial {w}_{ij} ( t )} + {w}_{ij} ( t ) + α ( {w}_{ij} ( t ) - {w}_{ij} ( t - 1 ) )$$
where wᵢⱼ(t+1) represents a connection weight between a node i and a node j for a repetition t+1 of steps (a) and (b), η is a learning rate parameter, E represents an error associated with output of a plurality of nodes j, wᵢⱼ(t) represents a connection weight between the node i and the node j for a repetition t of steps (a) and (b) prior to the repetition t+1, α is a momentum coefficient, and wᵢⱼ(t−1) represents a connection weight between the node i and the node j for a repetition t−1 of steps (a) and (b) prior to the repetition t.

7. The method of claim 6, wherein the values of the nodes are normalized to have a mean of zero and the learning rate parameter η is greater than zero but less than about 0.5.

8. The method of claim 6, wherein the learning rate parameter η has a value that varies as a function of a number of times a connection weight has been calculated.

9. The method of claim 3 further comprising determining values for a plurality of nodes comprising a gate layer associated with at least one of the at least three layers of the non-linear regression model, each of the plurality of nodes in the gate layer corresponding to one of the plurality of nodes in the associated layer.

10. The method of claim 9 further comprising choosing one of two values for each of the plurality of nodes comprising the gate layer, wherein a first value is chosen if the corresponding node in the associated layer comprises null data and a second value is chosen if the corresponding node in the associated layer does not comprise null data.

11. The method of claim 9 wherein the gate layer is associated with the input layer of the non-linear regression model.

12. The method of claim 9 wherein the gate layer is associated with the output layer of the non-linear regression model.

13. The method of claim 9 wherein the gate layer is associated with a hidden layer of the non-linear regression model.

14. An article of manufacture for training a non-linear regression model of a complex process, the article of manufacture comprising:
a process monitor for providing information representing values of a plurality of operational variables and corresponding values of a plurality of process metrics; and
a data processing device in signal communication with the process monitor, the data processing device receiving the information and determining a plurality of connection weights to be used in the non-linear regression model from the information,
wherein each of the plurality of connection weights is determined using a first weight relationship if the operational variable or corresponding process metric comprises a null data value and using a second weight relationship if neither the operational variable or the corresponding process metric comprise a null data value.

15. The article of manufacture of claim 14, wherein the non-linear regression model comprises at least three layers, each layer having a plurality of nodes,
wherein a plurality of nodes of an output layer represents the plurality of process metrics and a plurality of nodes of an input layer represent the plurality of operational variables; and
wherein the data processing device determining a first connection weight between a node of an output layer and a node of a last hidden layer of the non-linear regression model from the information, and determining a second connection weight between a node of an input layer and a node of a first hidden layer of the non-linear regression model by back-propagating the first connection weight.

16. The article of manufacture of claim 14 wherein the data processing device further determines if a convergence criterion is satisfied.

17. The article of manufacture of claim 14 wherein each of the plurality of connection weights corresponds to one of the plurality of operational variables and one of the plurality of process metrics.

18. The system of claim 14 wherein the process monitor comprises a database.

19. The system of claim 14 wherein the process monitor comprises a memory device including a plurality of data files, each data file comprising a plurality of scalar numbers representing associated values for nodes of the output layer and the input layer.

20. The system of claim 17 wherein each of the plurality of scalar numbers is normalized with a zero mean.

21. The system of claim 14 wherein first weight relationship implemented by the data processing device is of the form:
wᵢⱼ(t+1)=wᵢⱼ(t)+α(wᵢⱼ(t)−wᵢⱼ(t−1))
where wᵢⱼ(t+1) represents a connection weight between a node i and a node j for a repetition t+1 of steps (a) and (b), wᵢⱼ(t) represents a connection weight between the node i and the node j for a repetition t of steps (a) and (b) prior to the repetition t+1, α is a momentum coefficient, and wᵢⱼ(t−1) represents a connection weight between the node i and the node j for a repetition t−1 of steps (a) and (b) prior to the repetition t.

22. The system of claim 14 wherein first weight relationship implemented by the data processing device is of the form:
$${w}_{ij} ( t + 1 ) = η \frac{\partial E}{\partial {w}_{ij} ( t )} + {w}_{ij} ( t ) + α ( {w}_{ij} ( t ) - {w}_{ij} ( t - 1 ) )$$
where wᵢⱼ(t+1) represents a connection weight between a node i and a node j for a repetition t+1 of steps (a) and (b), η is a learning rate parameter, E represents an error associated with output of a plurality of nodes j, wᵢⱼ(t) represents a connection weight between the node i and the node j for a repetition t of steps (a) and (b) prior to the repetition t+1, α is a momentum coefficient, and wᵢⱼ(t−1) represents a connection weight between the node i and the node j for a repetition t−1 of steps (a) and (b) prior to the repetition t.
